(19) United States
(12) Patent Application Publication
(10) Pub. No.: US 2007/0292558 A1
(43) Pub. Date: Dec. 20, 2007

(54) Rail and pillar hot runner

(75) Inventors: Robert Frederick Irwin, Essex, VT (US); Patrice Fabien Gaillard, Milton, VT (US)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(73) Assignee: Husky Injection Molding Systems Ltd.

(21) Appl. No.: 11/452,772

(22) Filed: Jun. 14, 2006

(51) Int. Cl. B29C 45/00

(52) U.S. Cl. 425/570

(57) ABSTRACT

A hot-runner assembly for injection molding equipment. The hot-runner assembly includes a front plate and a backing plate spaced from one another so as to define an inter-plate volume. The inter-plate volume contains one or more manifolds for conducting flowable material to a plurality of injection nozzles. The inter-plate volume also contains inter-plate support distributed between a first inter-plate support zone located immediately adjacent the manifold(s) and a second inter-plate support zone that makes up the balance of the inter-plate volume so that the first inter-plate support zone has a inter-plate support footprint density that is greater than the inter-plate support footprint density in the second inter-plate support zone.

### TECHNICAL FIELD OF THE INVENTION

The present invention generally relates to the field of injection molding. In particular, the present invention is directed to a hot-runner assembly.

### DESCRIPTION OF THE RELATED ART

Injection molding of items made of plastic or other materials that cure, harden or otherwise solidify from a fluid or otherwise flowable state typically requires expensive and finely crafted injection-molding equipment. An important component of most injection-molding equipment is the hot-runner assembly, which generally includes one or more manifolds for distributing the flowable material to a number of injection nozzles for injecting the flowable material into one or more mold cavities. The hot-runner assembly also typically includes a support structure that supports the nozzles and manifold(s) and allows the assembly to be secured to a mold or other support.

Hot-runner support structures come in a variety of types and configurations. For example, some hot-runner support structures utilize a three-plate design that includes a “front plate,” i.e., a plate that confronts the mold with which it is used, a backing plate and a spacer plate sandwiched between the front plate and backing plate. The spacer plate includes one or more cutouts corresponding respectively to the one or more manifolds. Each of the cutouts typically conforms to the shape of the manifold that it contains. When these parts are assembled, each manifold is contained between the front and backing plates. U.S. Pat. No. 6,530,775 to Yu shows a hot-runner assembly having this type of hot-runner support structure.

Another type of hot-runner support structure commonly encountered is the two-plate design that includes a manifold plate and a closure, or backing plate. The manifold plate confronts the mold with which the hot-runner assembly is used and contains a cavity that conformally receives a corresponding manifold. The backing plate is fastened to the manifold plate so as to close the manifold in the cavity. This construction is similar to the three-plate design. The primary difference is that in the two-plate design the single manifold cavity plate functions as both the front and spacer plates of the three-plate design. U.S. Pat. No. 6,368,542 to Steil et al. shows a two-plate hot-runner support structure.

In other types of hot-runner assemblies, such as shown in U.S. Pat. No. 4,422,841 to Alfonsi et al., the support structure does not include a front plate, or its equivalent, between the manifold(s) and the mold. In these types, the hot-runner assemblies are integrated with the respective molds and typically include only spacer plates and backing plates, much in the same manner as described above in connection with the three-plate design. However, instead of the spacer plate engaging a front plate, it engages the mold directly.

In general, most conventional hot-runner assemblies that utilize backing plates and spacers, e.g., plates and portions of manifold plates, do not have optimally efficient designs. What are needed are hot-runner assemblies that utilize construction materials efficiently in terms of cost and effectiveness without compromising the integrity of the assemblies.

### SUMMARY OF THE INVENTION

In one embodiment, the present invention is directed to a hot-runner assembly. The hot-runner assembly comprises a manifold operatively configured to distribute flowable material to each of a plurality of injection nozzles. The manifold has a peripheral shape. The hot-runner assembly further comprises a front plate and a backing plate spaced from the front plate so as to define an inter-plate volume having an outer periphery. The inter-plate volume contains the manifold and is partitioned into a first inter-plate support zone and a second inter-plate support zone. The first inter-plate support zone extends from the manifold to an inter-zone boundary separating the first inter-plate support zone from the second inter-plate support zone and conforming to the peripheral shape of the manifold. The first inter-plate support zone has a width from 30 mm to 80 mm, a first inter-plate support footprint density and a first area. The second inter-plate support zone extends from the inter-zone boundary to the outer periphery of the inter-plate volume and has a second inter-plate support footprint density and a second area at least 50% greater than the first area. Inter-plate support is located within the inter-plate volume and is apportioned between the first inter-plate support zone and the second inter-plate support zone so that the first inter-plate support footprint density is at least 0.08 mm²/mm² greater than the second inter-plate support footprint density at at least one value of the width of the first inter-plate support zone.

In another embodiment, the present invention is directed to a hot-runner assembly. The hot-runner assembly comprises a manifold having a peripheral shape. The hot-runner assembly also comprises a front plate and a backing plate spaced from the front plate so as to define an inter-plate volume having an outer periphery. The inter-plate volume contains the manifold and is partitioned into a first inter-plate support zone and a second inter-plate support zone. The first inter-plate support zone extends from the manifold to an inter-zone boundary separating the first inter-plate support zone from the second inter-plate support zone and conforming to the peripheral shape of the manifold. The first inter-plate support zone has a width in a range from 30 mm to 80 mm and a first inter-plate support footprint density. The second inter-plate support zone extends from the inter-zone boundary to the outer periphery of the inter-plate volume and has a second inter-plate support footprint density. Inter-plate support is located within the inter-plate volume and is apportioned between the first inter-plate support zone and the second inter-plate support zone so that the first inter-plate support footprint density is at least 0.08 mm²/mm² greater than the second inter-plate support footprint density over the entire range of the width.

In a further embodiment, the present invention is directed to a hot-runner assembly. The assembly comprises a front plate having a plurality of first openings. A backing plated is spaced from the front plate and has a plurality of second openings. A manifold is operatively configured to distribute molten material and is located between the front plate and the backing plate. Inter-plate support is located between the front plate and the backing plate and comprises a plurality of discrete structures each having a third opening. A plurality of spring pins each have a first end engaged within a corresponding respective third opening and a second end engaged within a corresponding respective one of the plurality of first openings and the plurality of second openings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a transverse cross-sectional view of a hot-runner assembly made in accordance with the present invention;

FIG. 2A is a schematic cross-sectional view of the hot-runner assembly of FIG. 1 as taken along line 2-2 through the inter-plate volume between the front plate and backing plate so as to show a footprint of the structures present in the inter-plate volume;

FIG. 2B is a graph showing the inter-plate support footprint density in each of the first and second inter-plate support zones of the hot-runner assembly and inter-plate volume of FIGS. 1 and 2A;

FIG. 3 is an enlarged exploded view of a portion of the hot-runner assembly of FIG. 1 showing a detail of one of the pillars with a fastener partially inserted into the pillar;

FIG. 4 is a schematic cross-sectional view of another hot-runner assembly made in accordance with the present invention showing the footprint of structures present in the inter-plate volume between the front plate and backing plate; and

FIG. 5 is a schematic cross-sectional view of yet another hot-runner assembly made in accordance with the present invention showing the footprint of structures present in the inter-plate volume between the front plate and backing plate.

### DETAILED DESCRIPTION

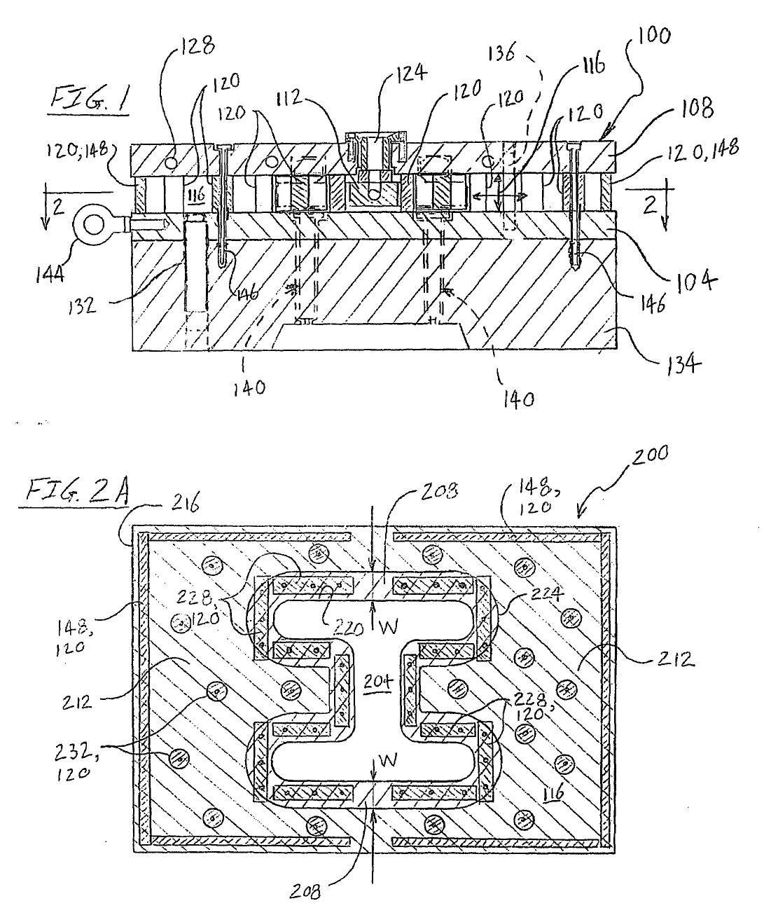

Referring now to the drawings, FIG. 1 illustrates in accordance with the present invention a hot-runner assembly, which is generally denoted by the numeral 100. The hot runner assembly 100 comprises a front plate 104, a backing plate 108 and one or more manifolds 112 located between the front and backing plates 104, 108 in what is referred to herein as an “inter-plate volume” 116. In general, the inter-plate volume 116 results from the front plate 104 and backing plate 108 being held in spaced relation to one another by inter-plate support 120 located within the inter-plate volume 116. As will become apparent from reading this entire disclosure, including the claims appended hereto, an important aspect of the present invention is the arrangement of the inter-plate support 120 within the inter-plate volume 116. For the sake of completeness and as those skilled in the art will readily appreciate, other components of the hot-runner assembly 100 may include one or more manifold inlets 124 for delivering a molten material (not shown) to each manifold 112, backing plate cooling elements, e.g., passageways 128 for a coolant (not shown), guide pins 132 for aligning the assembly with a mold structure 134, backing plate alignment dowels 136, injection nozzles or injection nozzle/valve assemblies 140, heating elements (not shown), one or more lifting fittings 144 and fasteners 146 for securing the various components to one another. The hot-runner assembly 100 may also include a peripheral closure 148, which may or may not be part of the inter-plate support 120, as discussed below.

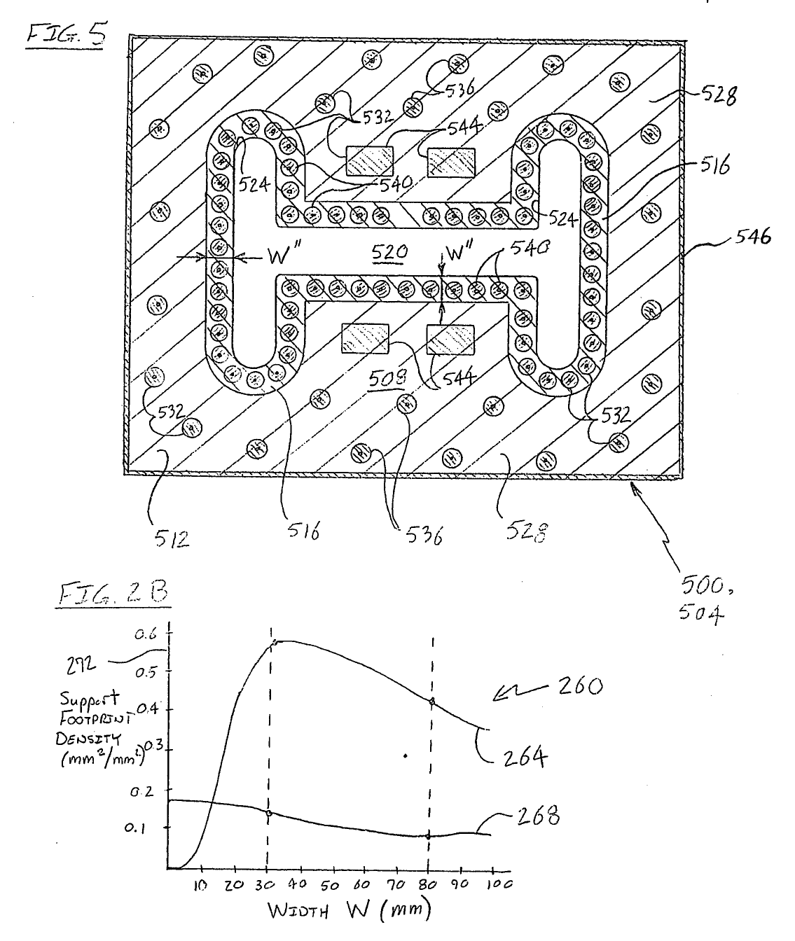

Referring to FIG. 2A, and also to FIG. 1, FIG. 2A generally shows a footprint 200 of the structures, e.g., the manifold(s) 112 and inter-plate support 120, present in the inter-plate volume 116. The Inter-plate volume 116 extends between the surfaces of the front plate 104 and backing plate 108 that face one another and laterally to the outer periphery(ies) of the plate(s) 104, 108 at which the overlap of the plates ends. For example, if both the front plate 104 and backing plate 108 have the same plan area and shape and the plates are in registration with one another, the lateral extent of the inter-plate volume 116 ends at the peripheries of both plates 104, 108. However, if one or the other of the front plate 104 and backing plate 108 has a plan area and shape that is different from the other plate 104, 108, the inter-plate volume 116 extends only to point where the overlap ends. For example, if both the front plate 104 and backing plate 108 are square in plan, but one is larger than the other, if the smaller plate fully overlaps the larger plate, then the inter-plate volume 116 will have the same lateral extend as the smaller plate. If both the front plate 104 and backing plate 108 are rectilinear and are spaced apart in a parallel manner so the surfaces that face each other are parallel and the edges of one plate are parallel to the edges of the other plate (which will typically be the case), then the inter-plate volume 116 will be rectilinear as well.

The footprint 200 contains a manifold region 204 that corresponds to the full lateral extent of the space within the inter-plate volume 116 occupied by the manifold 112. The remaining portion of the footprint 200 is partitioned into a first inter-plate support zone 208 immediately adjacent the manifold region 204 and a second inter-plate support zone 212 that extends from the first inter-plate support zone 208 to the outer periphery 216 of the footprint, i.e., the outer periphery of the inter-plate volume 116. The first inter-plate support zone 208 extends in a normal direction from the periphery 220 of the manifold region 204 around the entire periphery 220 and has a constant width W that extends from the periphery of the manifold region to an inter-zone boundary 224 between the first inter-plate support zone 208 and the second inter-plate support zone 212. Of course, having a constant width W from the periphery 220 of the manifold region 204, the inter-zone boundary 224 and the first inter-plate support zone 208 each have a shape that conforms to the shape of the outer periphery of the manifold 112.

Partitioning the footprint 200 into the first inter-plate support zone 208 and the second support zone 212 as shown allows the amount of inter-plate support 120 to be defined in terms of these two zones. In considering the amount of material used for the inter-plate support 120 and the need to keep deflections of the front plate 104 and other components of the hot-runner assembly 100 within acceptable limits, it has been found that providing the inter-plate support 120 in particular amounts within each of the first and second inter-plate support zones 208, 212 yields a good balance between these competing criteria. For the sake of this disclosure and the claims appended hereto, it has been found convenient to express the amount of the inter-plate support 120 in each of the first and second inter-plate support zones 208, 212 in terms of an “inter-plate support footprint density,” which is calculated for each zone by dividing the footprint area of the inter-plate support 120 within that zone by the footprint area of that zone. For example, if the footprint area of the first inter-plate support zone 208 is 110,640 mm² and footprint area of the inter-plate support 120 within first inter-plate support zone 208 is 62,800 mm², then the inter-plate support footprint density in the first inter-plate support zone 208 is 62,800 mm²/110,640 mm², which equals about 0.57 mm²/mm².

For practical reasons, it has also been found convenient to define the width W of the first inter-plate support zone 208 as being any value from 30 mm to 80 mm. Using such a range for width W will typically translate into the inter-plate support footprint density within each of the first and second inter-plate support zones 208, 212 varying with the width W of the first inter-plate support zone 208. For the sake of illustration, FIG. 2B illustrates an exemplary graph 260 of the inter-plate support footprint density in each of the first and second inter-plate support zones 208, 212 for values of the width W of the first inter-plate support zone 208 ranging from 0.0 mm (at which only the second inter-plate support zone 212 is present) to 100.0 mm. The inter-plate support footprint density in the first inter-plate support zone 208 is represented by line 264, and the inter-plate support density in the second inter-plate support zone 212 is represented by line 268.

While the 0.0 mm to 100.0 range shown in graph 260 extends beyond the practical range of 30 mm to 80 mm mentioned above, it gives the reader insight into the character of the inter-plate support of a hot-runner assembly made in accordance with the present invention, such as the inter-plate support 120 of hot-runner assembly 100 of FIG. 1. Broadly, a primary intention of this disclosure is to present hot-runner assemblies in which the inter-plate support footprint density in the first inter-plate support zone 208, i.e., the zone immediately adjacent the manifold 112 (FIG. 1), is greater than the inter-plate support footprint density in the second inter-plate support zone 212, i.e., the zone located away from the manifold 112. While the presence of this situation is usually readily discernable by eye, it is generally more difficult to define the situation concretely in dimensional terms.

One way it has been found suitable for defining the desire for a greater inter-plate support footprint density within the first inter-plate support zone 208 (FIG. 2A) than in the second inter-plate support zone 212 is to, as mentioned above, set the width W of the first inter-plate support zone equal to values in the range of 30 mm to 80 mm and then characterize the inter-plate support footprint densities in the first and second inter-plate support zones 208, 212 in terms of this range.

Using this characterizing technique, it is beneficial for the inter-plate support footprint density in the first inter-plate support zone of a hot-runner assembly made in accordance with the present invention, such as the first inter-plate support zone 208, to be at least 0.08 mm²/mm² greater than the inter-plate support footprint density in the second inter-plate support zone, such as the second inter-plate support zone 212, at any one or more values of the width W in a range of 30 mm to 80 mm. Relating this concept to the plot 260 of FIG. 2B, this translates into there being at least one value of the width W with the range of 30 mm to 80 mm where the “distance” between the lines 264, 268 parallel to the Y-axis 272 of the graph 260 is at least 0.08 mm²/mm² as “measured” along the Y-axis 272. More preferably, it is desirable that this minimum difference of 0.08 mm 1 mm be present at every value of the width W in the range of 30 mm to 80 mm. Even more preferable, it is desired that the inter-plate support footprint density in the first support zone 208 be at least 0.25 mm²/mm² greater than the inter-plate support footprint density in the second support zone 212 over the entire 30 mm to 80 mm range. Clearly, the example of graph 260 meets these requirements because the inter-plate support footprint density in the first support zone 208, as represented by line 264, is no less than about 0.36 mm²/mm² greater than the inter-plate support footprint density in the second support zone 212, as represented by line 268. This minimum occurs where the value of width W is 80 mm. The maximum difference occurs at a value of the width W equal to 30 mm, where the inter-plate support footprint density in the first support zone 208 is about 0.48 mm²/mm² greater than the inter-plate support footprint density in the second support zone 212.

It has also been found desirable to provide the first inter-plate support zone 208 with greater than about a 0.35 mm²/mm² inter-plate support footprint density at at least one value of the width W in the 30 mm to 80 mm range, and provide the second inter-plate support zone 212 with less than about a 0.60 mm²/mm² inter-plate support footprint density at at least one value of the width W within that range, particularly when the inter-plate support footprint density of the first inter-plate support zone 208 is greater than the inter-plate support footprint density of the second inter-plate support zone 212. In general, the higher the inter-plate support footprint density within the first inter-plate support zone 208 is above about 0.35 mm²/mm², the better the deflection performance of the hot-runner assembly 100.

For example, in some embodiments the maximum inter-plate support footprint density in the first inter-plate support zone 208 over a range of 30 mm to 80 mm for width W is greater than about 0.40 mm²/mm², and in other embodiments the maximum inter-plate support footprint density over this range is greater than about 0.50 mm²/mm² or even about 0.75 mm²/mm². Generally, the most practical range of the maximum inter-plate support footprint density in the first inter-plate support zone 208 for the width W in the range of 30 mm to 80 mm is about 0.40 mm²/mm² to about 0.65 mm²/mm². In most cases, it will be impractical, if not impossible, to provide the first inter-plate support zone 208 with an inter-plate support footprint density of 1.00 mm²/mm². This is so because in many designs a gap must be provided between the manifold 112 and the inter-plate support 120 to allow for thermal insulation and differential thermal expansion of the manifold 112. Further, unsupported areas may be present in the location of fasteners. In addition, in many designs the manifold 112 will be heated and will require cabling (not shown) or other element(s) to encroach within the first inter-plate support zone 208.

On the other hand and in general, the lower the maximum inter-plate support density within the second inter-plate support zone 212 in the 30 mm and 80 mm range of width W is below about 0.60 mm²/mm², the less material is needed for the inter-plate support 120. For example, in some embodiments, the maximum inter-plate support footprint density in the second inter-plate support zone 212 may be less than 0.50 mm²/mm², and in other embodiments less than 0.35 mm²/mm² or 0.20 mm²/mm². It is typically desirable, though not necessary, that the portion of the inter-plate support 120 located in the second inter-plate support zone 212 be distributed fairly evenly throughout the second inter-plate support zone 212. A most preferred range of the maximum inter-plate support footprint density within the second inter-plate support zone 212 is from about about 0.40 mm²/mm² to about 0.05 mm²/mm² over the 30 mm to 80 mm range of the width W. It will be readily appreciated that while the inter-plate support densities have been described above in terms of footprint areas, these densities also hold when the inter-plate support 120 is made up of constant cross-sectional area structures.

The inter-plate support 120 may be provided in any of a wide variety of forms, including discrete structures, i.e., structures formed separately from the front plate 104 and the backing plate 108 and engaged between the plates 104, 108 during assembly, and integral structures, i.e., structures formed integrally with either of the front and backing plates, e.g., during molding and/or milling. In addition, as those skilled in the art will appreciate, the structures that make up the inter-plate support 120 may have any of a variety of sizes and shapes. When selecting the sizes and shapes, and even form, of the structures of the inter-plate support, it is beneficial to consider the impact the selections have on the overall cost of making a hot-runner assembly of the present invention. FIGS. 2, 4 and 5 contain examples illustrating some of the wide variety of structures that may be used for the inter-plate support in the first and second inter-plate support zones within the inter-plate volume.

As illustrated best in FIG. 2A, the inter-plate support 120 comprises a plurality of rectilinear bars, or rails 228, in the first inter-plate support zone 208 and a plurality of cylindrical pillars 232 in the second inter-plate support zone 212. As seen, the rails 228 may be of differing lengths and arranged end-to-end so as to form a substantially continuous conglomerate structure around the manifold region 204. To make the use of the rails 228 economical, they may be cut from stock bar material and provided with an appropriate number of fasteners 146 of FIG. 1 and/or positioning aids, e.g., pins, dowels, clips, etc., as possible. The ends of the rails 228 may be, e.g., cross-cut, cylindrically rounded or mitered so as to formed clean mitered joints with adjacent rails.

Generally, it can be beneficial to provide each rail 228 with at least one positioning aid that inhibits rotation and translation of that rail relative to the front and backing plates 104, 108 (FIG. 1) either during assembly or after assembly, or both. An example of a single-type positioning aid is a non-circular pin (not shown) or protrusion a rail 228 that snugly engages a like-shaped opening in one of the front and backing plates 104, 108 (FIG. 1). Another example of a single-type positioning aid is a recess formed in one, the other or both of the front and backing plates 104, 108 that snugly receives a corresponding respective one of the rails 228. In cases in which a single positioning aid is used, one or more fasteners may be located proximate that rail 228 or extend into or through the rail so as to draw the parts into mating contact with one another. If two or more positioning aid are provided, each may be a simple cylindrical pin, dowel, fastener or protrusion. Of course, such positioning aid may be other shapes as well. In other embodiments, the rails 228 may be secured to one or both of the front and backing plates 104, 108 (FIG. 1) in another manner, such as welding, brazing, bonding, etc.

Like the rails 228, each pillar 232 may have any shape desired. The cylindrical shape shown is a very simple shape and has the benefit that when a central aperture is provided, e.g., for a fastener and/or an alignment structure (such as the spring pin 300 of FIG. 3), whether or not the pillar 232 rotates during assembly is typically of no concern. In the case of some or all of the pillars 232 being the same size, they may all be cut from the same bar stock quite inexpensively. Also like the rails 228, each pillar 232 may include one or more positioning aids, such as a spring pin 300 as shown in FIG. 3. The spring pin 300 may be a thin, substantially cylindrical band of a suitable material, such as spring steel, that is designed to extend into an opening 304 in the front plate 104 (or the backing plate 108) and a corresponding opening in the pillar 232, such as central opening 308. In its relaxed state, the spring pin 300 may have an outside diameter larger than the inside diameters of at least the portion of each of the opening 304 and the central opening 308 that the pin is designed to engage. Consequently, the spring pin 300 may be inserted into either of the openings 304, 308 by suitably compressing the band radially and inserting it into the corresponding opening. In this example, the central opening 308 is designed to receive a threaded fastener 312 that extends through the backing plate 108, the pillar 232 and the spring pin 300 and threadedly engages the front plate 104 within the opening 304. Of course, the positioning aid(s) provided may be of virtually any type other than the spring pin 300, such as any one or more of the positioning aid described above in connection with the rails 228.

Referring again to FIG. 2A, and also to FIG. 1, as mentioned above, in this example the hot-runner assembly 100 (FIGS. 1 and 2A) includes a peripheral closure 148 located proximate to the outer periphery 216 of the footprint 200. The peripheral closure 148 may be provided to essentially seal most of the inter-plate volume 116 from the environment surrounding the hot-runner assembly 100. This may be done for any of a number of reasons, including thermal control, aesthetics and protection of various components within the inter-plate volume 116. In the present example, the peripheral closure 148 is made of a material and of a sufficient thickness to function as part of the inter-plate support 120. In other embodiments, the peripheral closure 148 or the like may not be provided at all, or may be provided in such a manner that it does not function, at least in any significant manner, as part of the inter-plate support 120. For example, in the latter case, a peripheral closure may be made of a thin sheet-metal incapable of carrying any loads of any significance.

Based on finite element analyses of hot-runner assemblies made in accordance with the present invention, it has been found that the above-described configuration of the inter-plate support, e.g., the inter-plate support 120 of FIGS. 1 and 2, can be enhanced by providing the first inter-plate support zone 208 with an inter-plate support material having a higher yield strength and/or higher Young's Modulus than the inter-plate support material provided in the second inter-plate support zone 212. For example, the inter-plate support material in the first inter-plate support zone 208 may be a high-strength steel, such as high-strength stainless steel having a yield strength of 120 ksi (827 MPa) or more, wherein the inter-plate support material in the second inter-plate support zone 212 may be a lower strength steel, such as low-strength stainless steel having a yield strength of, e.g., 45 ksi (310 MPa) to 80 ksi (552 MPa). Of course, other materials can be used.

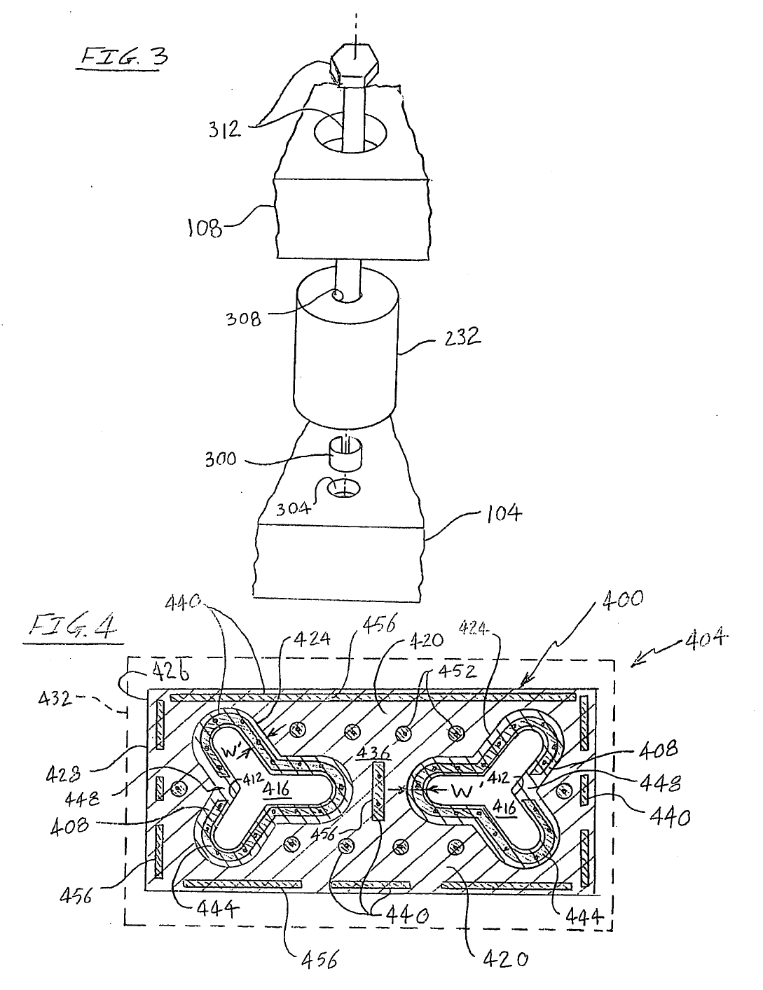

FIG. 4 illustrates a footprint 400 of another hot-runner assembly 404 made in accordance with the present invention. As described below, the footprint 400 illustrates an embodiment that is different from the hot-runner assembly 100 of FIG. 1 in a number of respect. However, aspects of the footprint 400 and the hot-runner assembly 404 that are the same as in the hot-runner assembly 100 and the footprint 200 of FIGS. 1 and 2A, respectively, are that the first inter-plate support zone 408 is considered to extend a constant width in a range of 30 mm to 80 mm in an outwardly normal direction from any point on the peripheral edges 412 the two manifold regions 416, and the second inter-plate support zone 420 extends from the boundaries 424 between the first and second inter-plate support zone to the boundary 426 where the overlap of the front plate 428 and the backing plate 432 ends. Obviously, in this embodiment the backing plate 432 is larger in plan area than the front plate 428 so that the cross-sectional area of the inter-plate volume 436 parallel to the front and backing plates, as represented in FIG. 4 by the footprint 400, is defined by the outer peripheral edge of the front plate 428.

In addition to the front and backing plates 428, 432 being different sizes and there being two manifold regions 416 rather than one, another difference between the hot-runner assembly 404 of FIG. 4 and the hot-runner assembly 100 and the footprint 200 of FIGS. 1 and 2A is the type of the inter-plate support 440 present in each of the first and second inter-plate support zones 408, 420. Whereas the portion of the inter-plate support 120 in the first inter-plate support zone 208 of the hot-runner assembly 100 comprises a plurality of rails 228, the portion of the inter-plate support 440 in the first inter-plate support zone 408 of the hot-runner assembly 404 are two elongate members 444 that each conformally extend substantially all of way around a corresponding respect one of the two manifold regions 416. In this example, each conformal member 444 does not extend all the way around the corresponding manifold region 416 to allow an opening 448 for a heating element or cabling therefor (not shown) to extend into that manifold region. Of course, there are other ways of running a heating element or cabling into the manifold regions 416, such as through one or more apertures in the respective conformal members 444 or through the backing plate 432.

Each conformal member 444 may be fastened to the front plate 428, the backing plate 432 or both using any suitable fastening means, such as the fastening means described above in connection with the hot-runner assembly 100 of FIGS. 1 and 2. As with the hot-runner assembly 100 of FIGS. 1 and 2, the maximum inter-plate support footprint density of the inter-plate support 440 within the first inter-plate support zone 408 may be at least about 0.35 mm²/mm² at at least one value of the width W′ in the 30 mm to 80 mm range, with higher densities, such as 0.40 mm²/mm², 0.50 mm²/mm², 0.75 mm²/mm², etc., being entirely appropriate. Moreover, it is desirable as with hot-runner assembly 100, above, that the inter-plate support footprint density in the first inter-plate support zone 408 to be at least 0.08 mm²/mm² greater than the inter-plate support footprint density in the second inter-plate support zone 420 at any one or more values of the width W′ in a range of 30 mm to 80 mm.

The portion of the inter-plate support 440 in the second inter-plate support zone 420 includes some cylindrical pillars 452 much in the same manner as in the inter-plate support 120 of FIGS. 1 and 2, but it also includes rails 456 as well. Generally, it is not the type of the inter-plate support 440 used, but rather the extent of the inter-plate support 440 within each of the first and second inter-plate support zones 408, 420 that is a feature of the present invention. For the second inter-plate support zone 420, as with the second inter-plate support zone 212 of FIG. 2, it is desirable that the maximum inter-plate support footprint density in the second inter-plate support zone 440 be at most about 0.60 mm²/mm² within the 30 mm to 80 mm range of the width W. In general, in the second inter-plate support zone 420, a typical goal is to reduce the amount of material needed for the inter-plate support 440 to the least amount of material while maintaining the integrity and robustness of the hot-runner assembly 404. In many cases, this means that the maximum inter-plate support footprint density in the second inter-plate support zone 420 can be less than 0.60 mm²/mm², such as 0.50 mm²/mm², 0.35 mm²/mm², 0.20 mm²/mm², etc.

As with the conformal members 444, the pillars 452 and the rails 456 may be secured to the front and backing plates 428, 432 using any suitable means for transferring the necessary loads and/or maintaining the stability of the various components of the hot-runner assembly 404. In addition to the types of the inter-plate support 440 being different as between the first and second inter-plate support zones 408, 420, the strength of the structures, i.e., the conformal members 444, the pillars 452 and the rails 456, provided may differ as between the differing zones or even in differing locations within the same zone so as to meet desired deflection criteria established by an experienced designer. Knowing the design criteria for a particular hot-runner assembly, e.g., the hot-runner assemblies 100, 404 of FIGS. 1 and 4, respectively, it will be within the ordinary skill of a hot-runner assembly designer to design suitable inter-plate support, e.g., the inter-plate supports 120, 440, respectively, in accordance with the present invention.

FIG. 5 illustrates a footprint 500 of yet another hot-runner assembly 504 made in accordance with the present invention. The footprint 500 is provided to illustrate that a wide variety of arrangements of inter-plate support that is possible under the present invention. Similar to the footprints 200, 400 of FIGS. 2A and 4, respectively, the footprint 500 represents an inter-plate volume 508 between a front plate 512 and a backing plate (not shown) and is considered to include a first inter-plate support zone 516 immediately surrounding a manifold region 520 and having a constant width W″ in a range of 30 mm to 80 mm extending perpendicularly/radially from the outer periphery 524 of the manifold region. Also like the footprints 200, 400, the rest of the area of the footprint 500 outside the first inter-plate support zone 516 and the manifold region 520 is considered a second inter-plate support zone 528. Furthermore, each of the first and second inter-plate support zones 516, 528 contains a respective portion of the inter-plate support 532 within the ranges discussed above in connection with the footprints 200, 400 of FIGS. 2A and 4, respectively. Briefly, it is desirable that the inter-plate support footprint density in the first inter-plate support zone 516 to be at least 0.08 mm²/mm² greater than the inter-plate support footprint density in the second inter-plate support zone 528 at any one or more values of the width W″ in a range of 30 mm to 80 mm. In addition, it is also desirable that the maximum inter-plate support footprint density of the inter-plate support 532 in each of the first and second inter-plate support zones 516, 528 be, respectively, greater than about 0.35 mm²/mm² and less than about 0.60 mm²/mm², with higher and lower densities, respectively, being more common.

In the example shown in FIG. 5, the portion of the inter-plate support 532 in the first inter-plate support zone 516 is made up of a plurality of cylindrical pillars 536, which can be much like the pillars 232, 452 of the second inter-plate support zones 212, 420, respectively, of FIGS. 2A and 4, including the way that they are secured to the front plate 512 and/or the backing plate and the way that they are held in position during assembly. The example of FIG. 5 also utilizes similar pillars 540 for the majority of the inter-plate support 532 in the second inter-plate support zone 528. However, to illustrate that many types of members may be used for the inter-plate support 532 in either the first or second inter-plate support zones 516, 528, the pillars 540 of the second inter-plate support zone 528 work in conjunction with four rectilinear inter-plate support members 544. Like the inter-plate support 120, 440 of FIGS. 2A and 4, the inter-plate support 532 of FIG. 5 may have differing yield strengths and/or Young's modulus in differing locations to suit deflection and/or stress criteria. The hot-runner assembly 504 includes a peripheral closure 546, but in this case it is of such a nature that it does not have any significant ability to carry inter-plate loads. Consequently, it is not considered to contribute to the inter-pate support 532.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A hot-runner assembly, comprising:
a manifold operatively configured to distribute flowable material to each of a plurality of injection nozzles, said manifold having a peripheral shape;
a front plate;
a backing plate spaced from said front plate so as to define an inter-plate volume having an outer periphery, said inter-plate volume containing said manifold and partitioned into a first inter-plate support zone and a second inter-plate support zone, wherein:
said first inter-plate support zone extends from said manifold to an inter-zone boundary separating said first inter-plate support zone from said second inter-plate support zone and conforming to said peripheral shape of said manifold, said first inter-plate support zone having a width from 30 mm to 80 mm, a first inter-plate support footprint density and a first area; and
said second inter-plate support zone extends from said inter-zone boundary to said outer periphery of said inter-plate volume and has a second inter-plate support footprint density and a second area at least 50% greater than said first area; and
inter-plate support located within said inter-plate volume and apportioned between said first inter-plate support zone and said second inter-plate support zone so that said first inter-plate support footprint density is at least 0.08 mm²/mm² greater than said second inter-plate support footprint density at at least one value of said width of said first inter-plate support zone.

2. A hot runner assembly according to claim 1, wherein said first inter-plate support footprint density is at least 0.35 mm²/mm² at at least one value of said width of said first inter-plate support zone.

3. A hot-runner assembly according to claim 1, wherein said second inter-plate support footprint density is no more than 0.60 mm²/mm² at said at least one value of said width of said first inter-plate support zone.

4. A hot-runner assembly according to claim 1, wherein said inter-plate support in said first inter-plate support zone is distributed substantially uniformly around said manifold.

5. A hot-runner assembly according to claim 4, wherein said inter-plate support in said first inter-plate support zone is substantially continuous around said manifold.

6. A hot-runner assembly according to claim 1, wherein said inter-plate support comprises a plurality of discrete members.

7. A hot-runner assembly according to claim 6, wherein at least some of said plurality of discrete members are rails located in said first inter-plate support zone.

8. A hot-runner assembly according to claim 6, wherein each of said plurality of discrete members includes positioning means engaging one of: (A) said front plate, (B) said backing plate and (C) said front plate and said backing plate.

9. A hot-runner assembly according to claim 8, wherein said positioning means includes a pin extending into a corresponding one of said plurality of discrete members and into one of: (A) said front plate and (B) said backing plate.

10. A hot-runner assembly according to claim 9, wherein said pin comprises a tubular spring.

11. A hot-runner assembly according to claim 6, wherein at least some of said plurality of discrete members are pillars located in said second inter-plate support zone.

12. A hot-runner assembly according to claim 1, further comprising a closure enclosing substantially all of said inter-plate volume proximate said outer periphery.

13. A hot-runner assembly according to claim 12, wherein said closure forms part of said inter-plate support.

14. A hot-runner assembly according to claim 1, wherein said inter-plate support in said first inter-plate support zone comprises a first material and said inter-plate support in said second inter-plate support zone comprises a second material different from said first material.

15. A hot runner-assembly according to claim 14, wherein said first material has a higher yield strength than said second material or a higher Young's modulus than said second material, or both.

16. A hot-runner assembly, comprising:
a manifold having a peripheral shape;
a front plate;
a backing plate spaced from said front plate so as to define an inter-plate volume having an outer periphery, said inter-plate volume containing said manifold and partitioned into a first inter-plate support zone and a second inter-plate support zone, wherein:
said first inter-plate support zone extends from said manifold to an inter-zone boundary separating said first inter-plate support zone from said second inter-plate support zone and conforming to said peripheral shape of said manifold, said first inter-plate support zone having a width in a range from 30 mm to 80 mm and a first inter-plate support footprint density; and
said second inter-plate support zone extends from said inter-zone boundary to said outer periphery of said inter-plate volume and has a second inter-plate support footprint density; and
inter-plate support located within said inter-plate volume and apportioned between said first inter-plate support zone and said second inter-plate support zone so that said first inter-plate support footprint density is at least 0.08 mm²/mm² greater than said second inter-plate support footprint density over the entire said range of said width.

17. A hot-runner assembly according to claim 16, wherein said first inter-plate support footprint density is at least 0.35 mm²/mm² at at least one value of said width of said first inter-plate support zone.

18. A hot-runner assembly according to claim 16, wherein said second inter-plate support footprint density is no more than 0.60 mm²/mm² at at least one value of said width of said first inter-plate support zone.

19. A hot-runner assembly according to claim 16, wherein said inter-plate support in said first inter-plate support zone is distributed substantially uniformly around said manifold.

20. A hot-runner assembly according to claim 19, wherein said inter-plate support in said first inter-plate support zone is substantially continuous around said manifold.

21. A hot-runner assembly according to claim 16, wherein said inter-plate support comprises a plurality of discrete members.

22. A hot-runner assembly according to claim 21, wherein at least some of said plurality of discrete members are rails located in said first inter-plate support zone.

23. A hot-runner assembly according to claim 21, wherein each of said plurality of discrete members includes positioning means engaging one of: (A) said front plate, (B) said backing plate and (C) said front plate and said backing plate.

24. A hot-runner assembly according to claim 23, wherein said positioning means includes a pin extending into a corresponding one of said plurality of discrete members and into one of: (A) said front plate and (B) said backing plate.

25. A hot-runner assembly according to claim 24, wherein said pin comprises a tubular spring.

26. A hot-runner assembly according to claim 21, wherein at least some of said plurality of discrete members are pillars located in said second inter-plate support zone.

27. A hot-runner assembly according to claim 16, further comprising a closure enclosing substantially all of said inter-plate volume proximate said outer periphery.

28. A hot-runner assembly according to claim 27, wherein said closure forms part of said inter-plate support.

29. A hot-runner assembly according to claim 16, wherein said inter-plate support in said first inter-plate support zone comprises a first material and said inter-plate support in said second inter-plate support zone comprises a second material different from said first material.

30. A hot runner-assembly according to claim 29, wherein said first material has a higher yield strength than said second material or a higher Young's modulus than said second material, or both.

31. A hot-runner assembly, comprising:
a front plate having a plurality of first openings;
a backing plated spaced from said front plate and having a plurality of second openings;
a manifold operatively configured to distribute molten material and located between said front plate and said backing plate;
inter-plate support located between said front plate and said backing plate and comprising a plurality of discrete structures each having a third opening; and
a plurality of spring pins each having a first end engaged within a corresponding respective said third opening and a second end engaged within a corresponding respective one of said plurality of first openings and said plurality of second openings.

32. A hot-runner assembly according to claim 31, wherein each of said plurality of spring pins is a tubular spring pin.
